(19) United States
(12) Patent Application Publication
(10) Pub. No.: US 2012/0312469 A1
(43) Pub. Date: Dec. 13, 2012

(54) METHOD AND MOULD FOR MOULDING A WIND TURBINE BLADE

(75) Inventor: Henrik Stiesdal, Odense C (DK)

(73) Assignee: SIEMENS AKTIENGESELLSCHAFT, Muenchen (DE)

(21) Appl. No.: 13/578,915

(22) PCT Filed: May 20, 2010
(86) PCT No.: PCT/EP2010/056988

§ 371 Date: Aug. 14, 2012

(30) Foreign Application Priority Data
Mar. 3, 2010 (EP) 10155295.8

(51) Int. Cl. B32B 37/10; B32B 37/00

(52) U.S. Cl. 156/289; 156/382; 156/349

(57) ABSTRACT

A mould for moulding a wind turbine blade using a reinforcing material and a matrix material is provided. The mould includes a solid non-stick lining, and wherein the material properties of the non-stick lining are chosen to prevent a matrix material from bonding with the non-stick lining of the mould. A method of moulding a wind turbine blade in a mould is also provided. The method includes applying a solid non-stick lining to an inside surface of the mould, assembling a reinforcement material lay-up for the wind turbine blade on the non-stick lining, distributing a matrix material through layers of the reinforcement material lay-up, performing curing steps to harden the matrix material, and subsequently removing the cured wind turbine blade from the mould.

### CROSS REFERENCE TO RELATED APPLICATIONS

This application is the US National Stage of International Application No. PCT/EP2010/056988, filed May 20, 2010 and claims the benefit thereof. The International Application claims the benefits of European Patent Office application No. 10155295.8 EP filed Mar. 3, 2010. All of the applications are incorporated by reference herein in their entirety.

### FIELD OF INVENTION

The invention describes a method of moulding a wind turbine blade, a film for use in a wind turbine blade moulding process, and the use of such a film in the moulding of a wind turbine blade.

### BACKGROUND OF INVENTION

The technique of closed-mould casting is widely used to manufacture large components that must be light as well as robust, for example wind-turbine blades. Such components can be made as composites, whose constituent materials comprise layers of rigid or semi-rigid reinforcing material (to give the component its structural stability) joined or melded throughout by a matrix material. The reinforcing material can be some suitable lightweight and flexible material such as glass or carbon fibre matting. The layers are built or laid up in a suitably shaped mould, and the layers of matting are bonded with a suitable matrix material and cured in the mould to give a fibre-reinforced polymer, a glass-reinforced plastic, etc. Such a method is described in EP 1 310 351 A1.

To facilitate releasing the finished component after curing, the mould is usually coated with a release agent such as a suitable wax so that the matrix material does not bond with the mould, which would make it effectively impossible to remove the component from the mould without damaging either one. The release agent is applied to the mould before laying up. Known release agents are polyvinyl alcohol, silicone wax, slip wax, etc. The release agent must be applied to the whole mould inside surface in a uniform thickness in order to ensure a smooth outer surface of the hardened component. However, it is not easy to apply the release agent so that these requirements are met, and, if improperly applied, an uneven release agent layer can result in an uneven or dimpled blade surface. Furthermore, the types of release agent generally used contain volatile solvents, which pose a health risk to anyone exposed to them. Another main disadvantage of having to use such a release agent is that, after curing, hardened remnants of the release agent can adhere to the blade in places. These must be removed so that the surface of the blade can be finished. Again, this can be a cost-intensive procedure, since the wind-turbine blades must be absolutely free of any such remnants before a final painting step can be carried out. Therefore, the remnants of release agent must be removed in a time-intensive procedure such as scrubbing or sandblasting, adding to the overall cost of manufacture.

In the moulding techniques known from the prior art such as vacuum-assisted resin transfer moulding (VARTM), small air pockets or bubbles can be trapped between the viscous or waxy release agent layer and the outer regions of the fabric layers. These air pockets can be opened up during finishing and appear as ‘pinholes’ on the outer surface of the blade. Since the pinholes result in pronounced surface irregularities after painting, they must be repaired by manually applying a pore-filler in a time-consuming and expensive additional step. Therefore, such pinhole defects are regarded as highly undesirable.

### SUMMARY OF INVENTION

It is therefore an object of the invention to provide an improved way of manufacturing a wind turbine blade by moulding, overcoming the problems mentioned above.

The object of the invention is achieved by the mould according to the claims for moulding a wind turbine blade, the method according to the claims of moulding a wind turbine blade, and the use according to the claims of such a mould and such a method in the moulding of a wind turbine blade.

The mould according to the invention, for use in moulding a wind turbine blade using a reinforcing material and a matrix material, comprises a solid non-stick lining, wherein the material properties of the non-stick lining are chosen to prevent the matrix material from bonding with the non-stick lining of the mould.

In the context of a mould for forming a composite, the matrix material is the substance used to bond and support the reinforcement layers. In the prior art moulding techniques, as described above, the matrix material will also bond to the mould unless a release agent is used. An obvious advantage of the mould according to the invention is that the solid non-stick lining makes a release agent unnecessary and, after curing, the wind turbine blade can easily be detached from the non-stick lining. Therefore, savings can be made as regards to time and cost, since no time need be spent with the exacting application of a release agent layer, and as regards to health, since workers need not be exposed to any solvent fumes. Furthermore, the surface of the blade, after curing and removal from the mould, is free of any problematic remnants of release agent and is essentially ready for a final finishing step such as painting. Also, the solid non-stick lining favourably inhibits air-pockets from being trapped at the outer surface of the component, so that pinholes are essentially prevented from developing. These positive aspects can save considerable time and expense while allowing the manufacture of a blade with a high-quality outer surface.

According to the invention, the method of moulding a wind turbine blade in a mould comprises the steps of applying a solid non-stick lining to an inside surface of the mould; assembling a reinforcement material lay-up for the wind turbine blade on the non-stick lining, which non-stick inside lining is preferably free of any release agent; distributing a matrix material through layers of the reinforcement material lay-up; performing curing steps to harden the matrix material; and subsequently removing the cured or hardened wind turbine blade from the mould.

Particularly advantageous embodiments and features of the invention are given by the dependent claims, as revealed in the following description. Features of the embodiments may be combined as desired to arrive at further embodiments.

In the following, the term ‘fabric layers’ is to be understood to mean the layers of reinforcing material that are laid up in the mould, and a matrix material can be included at the time of laying up. Alternatively, the matrix material (usually just referred to as ‘epoxy resin’ or just ‘resin’) can be added after laying up the layers of reinforcing material.

The term ‘solid’ in the context of the non-stick lining is used in the sense that the non-stick lining is not a wax or other semi-solid material, in order to distinguish it completely from any release agent that is manually applied to coat the inside of a mould in a prior art technique. In a particularly preferred embodiment of the invention, the solid non-stick lining comprises a layer of a polytetrafluoro-ethylene (PTFE) material, such as Teflon®, which is a registered trademark of the DuPont company. The solid non-stick lining can be applied just once to the inside surface of the mould, which can then be used multiple times without having to replace the non-stick lining.

Teflon and similar non-stick materials are available in a number of different product types and can be applied in various ways. For example, Teflon can be provided in pre-fabricated sheets or tapes, or even as a spray. The inside surface of the mould according to the invention could therefore be sprayed with the non-stick substance to give a favourably smooth lining. Alternatively, in another preferred embodiment of the invention, the non-stick material can be provided in the form of a sheet with an adhesive coating on the underside, which adhesive surface can adhere to an inside surface of the mould so that the non-stick surface faces outward.

The method according to the invention can be used for any moulding technique in which layers are laid up in a mould prior to curing. For example, an essentially hollow wind turbine blade can be made by separately moulding two half-shells which, after curing, are joined at leading and trailing edges by gluing these together. The structure can be given additional support by one or more beams bonded to the inside faces of the half-shells. However, it can be difficult to ensure a satisfactory quality of the glue joints, due to the different material properties such as the elastic modulus of the half-shells and the glue used to bond them along their entire lengths. In the case of a wind turbine blade, these glue joints present a potential weakness and may eventually crack or open as a result of the extreme forces that can act on the blade. Therefore, in a particularly preferred embodiment of the invention, the mould comprises a closed mould for manufacturing a wind turbine blade in one piece, with at least a first mould section and a second mould section which can be joined in an air-tight manner during a curing step. Preferably, both the first and second mould sections comprise a solid non-stick lining. Fabric layers can then be laid up in the mould, perhaps also using an inner mould as described in EP 1 310 351 A1 to give the blade additional structural support. In the closed-mould approach, the fabric layers can be arranged around a core or mandrel and the entire structure can then be enclosed in the mould. After curing, the mould is opened and the hardened wind turbine blade can be removed. Using this approach, it is possible to manufacture a large, hollow component such as a wind turbine blade in one piece and without any potentially critical glue joints.

In one approach, the composite lay-up can comprise layers of prepreg material, in which the reinforcing material layers are already soaked or impregnated with matrix material such as a thermosetting polymer or any suitable epoxy resin. To cure the layers, heat can be applied to the mould. To this end, the mould preferably comprises a heating element, for example a heating filament or coil embedded in the mould body. Prior to curing, air is usually drawn out of the closed mould so that the material layers expand to fill the mould and to press against the inside surface of the mould, thus ensuring a smooth outer surface of the finished component. To this end, the closed mould preferably comprises airtight seals to facilitate the development of a satisfactory vacuum.

In a particularly preferred embodiment of the invention, the mould is realised for use in a VARTM process in which the thermosetting polymer or epoxy resin is drawn or sucked into the closed mould and essentially evenly distributed about the reinforcement material layers. In another preferred embodiment, then, the mould preferably comprises an injection inlet for injecting a matrix material into the closed mould, and a vacuum extraction outlet for applying a vacuum to distribute the matrix material through layers of a reinforcement material lay-up. The injection inlet (or resin inlet) can be located at a lower level than the vacuum extraction outlet, which is usually located high up on the mould so that the air to be extracted can rise upward as the resin is forced into the closed mould. Usually, the closed mould is placed in an upright position after closing so that the resin can be optimally drawn in from the resin inlet at the bottom of the mould, while the air is optimally withdrawn through a vacuum extraction outlet at the top of the mould.

In a further embodiment of the invention, the mould can comprise a number of additional channels to facilitate the removal of air by vacuum extraction. Such a channel can be arranged in any appropriate way that would facilitate the extraction of air. Preferably, the mould comprise a plurality of channels, and these can be arranged to originate or terminate in the vicinity of a vacuum nozzle through which the air is drawn out from the mould.

When laying-up the composite material layers in the mould, cutting tools may be used to cut the layers to size. As a result, it may happen that the non-stick lining is damaged in places. In any areas from which the non-stick lining is nicked or chipped out, the matrix material would bond to the inside surface of the mould, leading to difficulties when removing the cured blade and possibly damaging the blade outer surface or the mould. Therefore, the step of applying the solid non-stick lining to the inside surface of the mould can comprise applying a piece or strip of non-stick lining to cover a defect in the non-stick lining (already applied to the mould) as required. For example, a thin strip of self-adhesive Teflon tape could be stuck onto the damaged region. Preferably, the strip can be cut to size to optimally cover the defect with little overlap. In this way, the non-stick lining can be repaired in a cost-effective and quick manner, by using just small pieces of tape to repair defects as they arise. Effectively, by being able to repair defects in this way, the solid non-stick lining can be re-used indefinitely.

However, depending on the reinforcing materials and the matrix materials used, it may be desirable to have some means of collecting any excess matrix material. Therefore, in a further embodiment of the invention, the method comprises an additional step of laying out an additional—disposable—layer of composite fabric on top of the solid non-stick lining prior to laying up the component layers. An example of such a composite fabric is Compoflex® (a product of the Fibertex company), which is made of several different functional layers. For example, a Compoflex® fabric comprising a bleeder layer and a breather layer can be used. The bleeder layer is designed to effectively absorb any excess resin that is exuded at the outer surfaces of the component, and the breather layer helps prevent air pockets being trapped near the component surface. After curing, this additional composite layer can be peeled off the hardened component and discarded.

The method according to the invention is particularly suited to the moulding of large wind turbine blades that must be light and require a smooth outer surface suitable for the application of paint. Therefore, in a preferred embodiment of the invention, the component to be moulded comprises layers of a suitable material or matting such as glass fibre or carbon fibre, which layers are bonded with a suitable matrix material such as resin, glue, thermosetting polymer, etc. The bonding can be carried out in any suitable way. For example, dry fibreglass matting can be coated in resin during a manual laying-up step. Alternatively, prepreg materials can be used. The curing or bonding can be performed by heating the mould, by applying UV-irradiation, etc.

### BRIEF DESCRIPTION OF THE DRAWINGS

Other objects and features of the present invention will become apparent from the following detailed descriptions considered in conjunction with the accompanying drawings. It is to be understood, however, that the drawings are designed solely for the purposes of illustration and not as a definition of the limits of the invention.

FIG. 1 shows a schematic representation of a cross-section through a mould with a reinforcement material lay-up in a prior art wind turbine blade moulding process;

FIG. 2 shows a schematic representation of a cross-section through a mould with a reinforcement material lay-up in one embodiment of the wind turbine blade moulding process according to the invention;

FIG. 3 illustrates a mending step for the solid non-stick lining in a mould according to the invention;

FIG. 4 shows a schematic representation of a cross-section through a mould with a reinforcement material lay-up in a further embodiment of the wind turbine blade moulding process according to the invention.

### DETAILED DESCRIPTION OF INVENTION

In the drawings, like reference numbers refer to like objects throughout. Objects in the diagrams are not necessarily drawn to scale. In particular, the thicknesses of the mould, release agent layer, non-stick lining, and reinforcement material lay-up are not to scale.

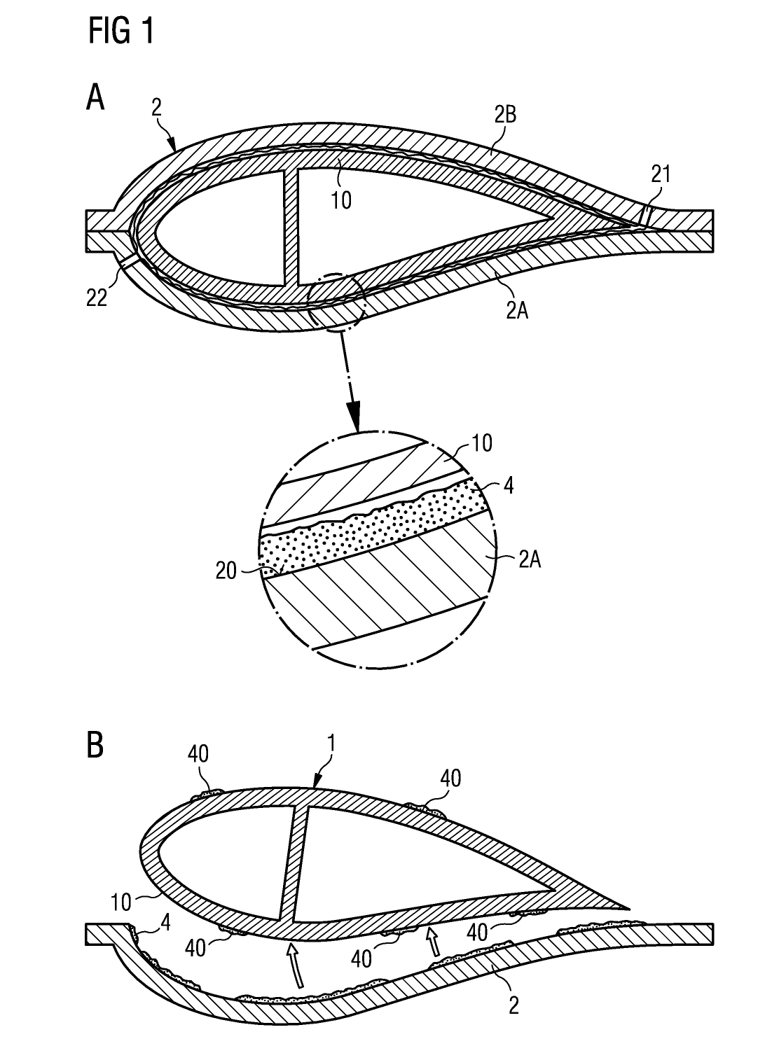

FIG. 1 shows a very simplified cross-section through a mould 2 with laid-up component layers 10 in a prior art component moulding process such as that described in EP 1 310 351 A1, in which a wind turbine blade is formed using a reinforcement material lay-up 10 and cured in a closed mould 2 into which an epoxy resin is injected under pressure. As part A of the diagram shows, the mould 2 comprises a vacuum extraction nozzle 21 through which air can be extracted during a vacuum extraction step, thus causing the component layers to expand, and a resin injection inlet 22 by means of which a matrix material is drawn into the mould 2 and distributed throughout the reinforcement material lay-up 10. To allow the cured wind turbine blade to be removed from the mould without damage to its surface, the inside surfaces 20 of the mould sections 2A, 2B must be prepared by coating them with a uniform layer of release agent 4 such as a slip wax 4. Even so, when removing the cured blade 1 from the mould 2, as shown in part B of the diagram, remnants 40 of the wax 4 can remain stuck to the outer surface of the blade 1, and must be removed in an additional step such as scrubbing or sandblasting. Also, before the mould 2 can be used again, the release agent layer 4 must either be removed by scraping it off the inside surface 20 of the mould sections 2A, 2B, or it must be smoothed again to give the required level of uniformity.

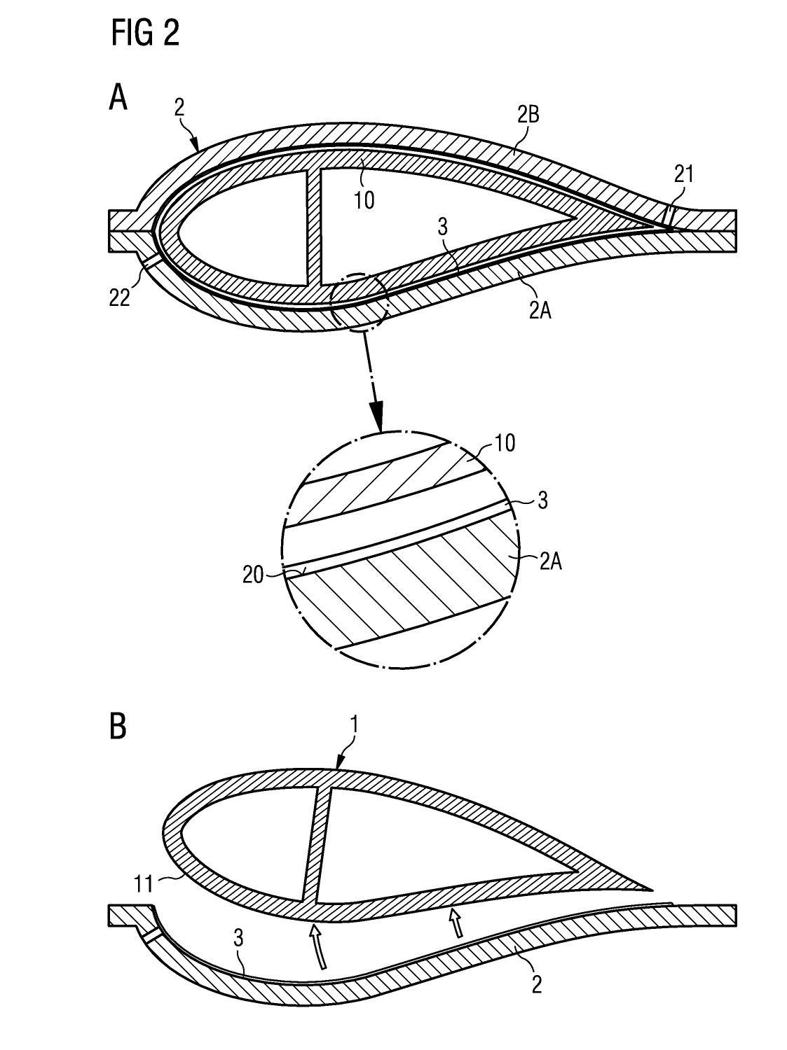

FIG. 2 shows a very simplified cross-section through a mould 2 with laid-up component layers 10 in a wind turbine blade moulding process according to the invention. Essentially, the mould of FIG. 1 can be used. However, in contrast to the set-up shown in FIG. 1, instead of using a release agent, the inside surfaces 20 of the mould sections 2A, 2B are lined with a solid non-stick lining 3 such as Teflon®, as shown in the upper part A of the diagram. The reinforcement material lay-up 10 can be completed in the usual manner before closing the mould 2 and performing a vacuum extraction step to extract air through a vacuum extraction nozzle 21 and to draw resin into the closed mould 2 via a resin injection inlet 22. Once the blade 1 is cured, it can be removed easily from the mould section 2A, as shown in the lower part B of the diagram. Since no release agent was required, the outer surface 11 of the blade 1 is clean and ready for a finishing step. The inside of the mould 2 is also clean and ready for use again.

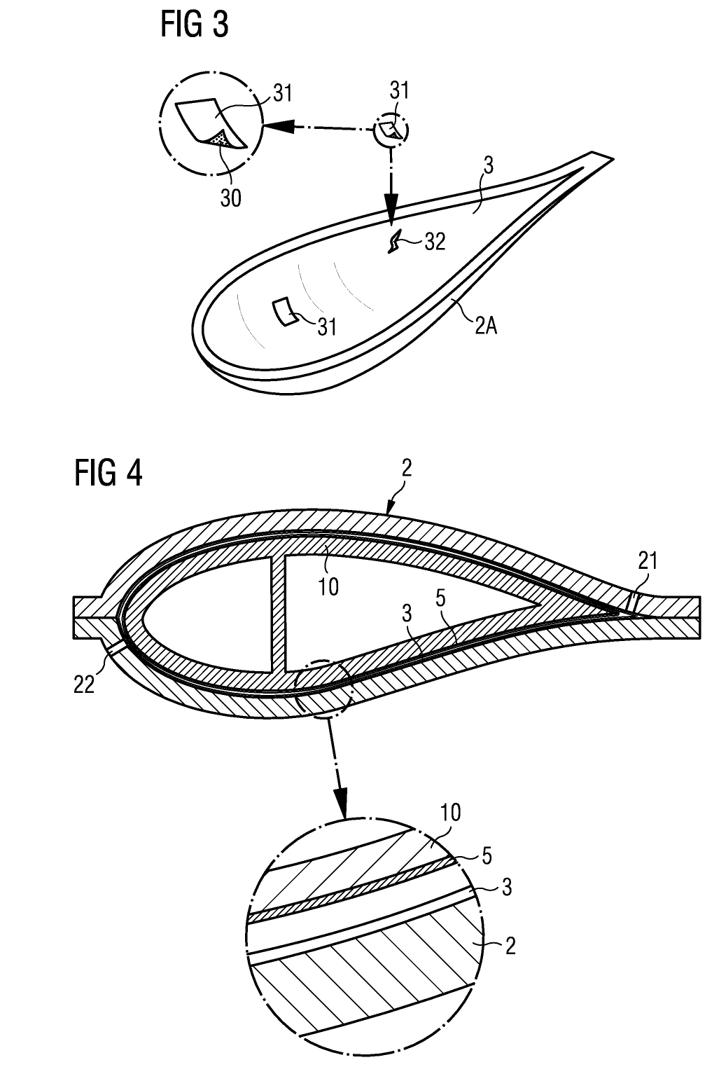

FIG. 3 illustrates a mending step for the solid non-stick lining 3 of a mould 2 according to the invention. Here, small defects 32 have appeared on the solid non-stick lining 3 of the mould section 2A. To mend a defect 32, a small patch 31 or strip 31 of non-stick lining material can be applied to cover the defect 32 and to ensure that the inside of the mould section 2A is uniformly covered with a non-stick lining 3. For ease of application, the strip 31 can be self-adhesive, i.e. the underside of the non-stick lining material can be coated with an adhesive coating 30. The non-stick lining material can be supplied, for example, on a roll or as a large sheet, from which a backing sheet can be peeled off. Initially, the entire mould section 2A can be lined using self-adhesive non-stick lining 3, and any defects 32 on the lining 3 arising during the lifetime of the mould can simply be repaired by applying small patches 31 of the same material 3.

FIG. 4 shows a very simplified schematic representation of a cross-section through a mould 2 with a reinforcement material lay-up 10 in a further embodiment of the wind turbine blade moulding process according to the invention. Here, an additional disposable composite layer 5 has been laid up on top of the solid non-stick lining. As mentioned above, such a composite layer 5, e.g. a Compoflex® layer 5, can be used to absorb excess resin and to assist in obtaining a smooth blade outer surface. In contrast to prior art methods that use such a disposable composite layer, the method according to the invention does not require any release agent to be applied to the inside of the mould 2. After curing, the disposable layer 5 can be peeled off the blade and discarded, while the non-stick lining 3 of the mould 2 is ready for use again.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-10. (canceled)

11. A mould for moulding a wind turbine blade using a reinforcement material lay-up comprising:
a solid non-stick lining,
wherein the reinforcement material lay-up comprises a reinforcing material and a matrix material,
wherein the material properties of the non-stick lining are chosen to prevent the matrix material from bonding with the non-stick lining of the mould when the reinforcement material lay-up is assembled on the solid non-stick lining.

12. The mould according to claim 11, wherein the non-stick lining comprises a layer of a polytetrafluoroethylene material.

13. The mould according to claim 12, wherein the underside of the non-stick lining comprises an adhesive coating, and the adhesive coating adheres to an inside surface of the mould.

14. The mould according to claim 11, wherein the mould comprises a closed mould with a first mould section and a second mould section.

15. The mould according to claim 14, wherein the mould is used in a vacuum-assisted resin transfer moulding process in which the matrix material comprises an epoxy resin.

16. The mould according to claim 14, further comprising an injection inlet for injecting a matrix material into the closed mould, and a vacuum extraction outlet for applying a vacuum to distribute the matrix material through layers of a reinforcement material lay-up.

17. A method of moulding a wind turbine blade in a mould, comprising:
applying a solid non-stick lining to an inside surface of the mould;
assembling a reinforcement material lay-up for the wind turbine blade on the non-stick lining;
distributing a matrix material through layers of the reinforcement material lay-up;
performing curing steps to harden the matrix material; and subsequently removing the cured wind turbine blade from the mould.

18. The method according to claim 17, wherein the applying the solid non-stick lining comprises applying a strip of self-adhesive non-stick lining material to cover a defect in the non-stick lining already applied to the mould.

19. The method according to claim 17, further comprising laying out a disposable composite fabric layer on the non-stick lining prior to laying up the reinforcement material.
